(19) United States
(12) Patent Application Publication
(10) Pub. No.: US 2014/0095214 A1
(43) Pub. Date: Apr. 3, 2014

(54) SYSTEMS AND METHODS FOR PROVIDING A DRIVING PERFORMANCE PLATFORM

(71) Applicants: Robert E. Mathe, Sarasota, FL (US); Terje Gloerstad, Scottsdale, AZ (US); Robert M. Wilkison, Scottsdale, AZ (US)

(72) Inventors: Robert E. Mathe, Sarasota, FL (US); Terje Gloerstad, Scottsdale, AZ (US); Robert M. Wilkison, Scottsdale, AZ (US)

(21) Appl. No.: 13/841,787

(22) Filed: Mar. 15, 2013

Related U.S. Application Data
(60) Provisional application No. 61/762,547, filed on Feb. 8, 2013.
(60) Provisional application No. 61/744,755, filed on Oct. 3, 2012.

(51) Int. Cl. G06Q 40/08

(52) U.S. Cl. CPC G06Q 40/08
USPC 705/4

(57) ABSTRACT

Systems and methods of providing a platform for a driving performance application. The platform includes receiving data associated with driving performance of a driver, where the driver is associated with a client of the platform, analyzing the data to determine a measure of driving performance, and reporting the measure of driving performance to the client. The platform interfaces with the native systems of the client to provide an integrated insurance platform capable of implementing and managing a driving performance product, such as a usage-based insurance product.

### CROSS REFERENCE TO RELATED APPLICATIONS

This application claims priority to, and the benefits of, U.S. provisional application Ser. No. 61/744,755 filed on Oct. 3, 2012, and U.S. provisional application Ser. No. 61/762,547 filed on Feb. 8, 2013, which are both incorporated by reference herein in full.

### BACKGROUND

Providing usage-based insurance, other insurance products, and/or fleet management can include capturing data associated with driving performance (e.g., driving activity or “usage”), which, in some cases, may also be relevant to a particular insurance policy. Because decisions may be based on that data, for example, restatements of price, it is important to ensure the integrity and/or quality of the data, for example, for both policy holders and providers.

The following patent applications are incorporated by reference herein in full: U.S. provisional application Ser. No. 61/749,600, U.S. application Ser. No. 13/835,381, U.S. application Ser. No. 13/837,955, U.S. application Ser. No. 13/839,681, and U.S. application Ser. No. 13/841,203.

### SUMMARY

In one embodiment, a method of providing a platform for a driving performance application, including receiving data associated with driving performance of a driver, wherein the driver is associated with a client of the platform, analyzing the data to determine a measure of driving performance, and reporting the measure of driving performance to the client.

The descriptions of the invention do not limit the words used in the claims in any way or the scope of the claims or invention. The words used in the claims have all of their full ordinary meanings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of this invention.

FIG. 1 illustrates a block diagram showing an exemplary insurance platform;

FIG. 2a illustrates a block diagram showing an exemplary integrated insurance platform including native insurance-based systems;

FIG. 2b illustrates a block diagram showing an exemplary integrated insurance platform including providing an exemplary usage-based insurance platform as a service;

FIG. 3 is a flowchart showing the steps of an exemplary embodiment to provide driving performance feedback to a user;

FIG. 4 is a flowchart showing the steps of an exemplary embodiment to provide a restatement of price to a user;

FIG. 5 is a flowchart showing the steps of an exemplary embodiment to provide a usage-based insurance platform as a service;

FIG. 6 illustrates an exemplary screenshot from an exemplary QOS application showing various QOS attributes;

FIG. 7 illustrates an exemplary screenshot from another exemplary QOS application showing occurrences of various QOS flags;

FIG. 8 illustrates an exemplary screenshot from an exemplary Mobile Network Portal, as part of another exemplary QOS application, showing various attributes of aggregated traffic data;

FIG. 9 illustrates an exemplary screenshot from an exemplary carrier center application, showing various attributes;

FIG. 10 illustrates an exemplary screenshot from an exemplary customer center application;

FIG. 11 illustrates an exemplary screenshot from an exemplary customer center application showing vehicle scoring and driving behavior feedback;

FIG. 12 is a flowchart showing the steps of an exemplary embodiment for order fulfillment;

FIG. 13 is a flowchart showing the steps of an exemplary embodiment to support case management; and

FIG. 14 includes an exemplary depiction of exemplary communication protocols and exemplary devices containing the application and/or executing the processes.

### DESCRIPTION

The following includes definitions of exemplary terms used throughout the disclosure. Both singular and plural forms of all terms fall within each meaning:

“Address”, as used herein, includes but is not limited to one or more e-mail addresses, a distribution list including one or more e-mail addresses, uniform resource locator (URL) and file transfer protocol (FTP) locations or the like, network drive locations, a postal address, a combination of an e-mail address and a postal address, or other types of addresses that can identify a desired destination.

“Computer Readable Medium”, as used herein, includes but is not limited to any memory device, storage device, compact disc, floppy disk, or any other medium capable of storing data temporarily and/or permanently that can be interpreted by a computer.

“Device”, as used herein, includes any machine or component that attaches to and/or communicates with a computing device. Examples of peripheral devices, which are separate from a main computing device, include disk drives, printers, mice, and modems. Examples of integrated peripherals, which are incorporated into a main computing device, include central processing units and application specific integrated circuits. Most devices, whether peripheral or not, require a program called a device driver that acts as a translator, converting general commands from an application into specific commands that the device understands. The telematics device (104) is an exemplary device.

“Internet”, as used herein, includes a wide area data communications network, typically accessible by any user having appropriate software.

“Intranet”, as used herein, includes a data communications network similar to an internet but typically having access restricted to a specific group of individuals, organizations, or computers.

“Logic”, synonymous with “circuit” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other logic device. Logic may also be fully embodied as software.

“Network”, as used herein, includes but is not limited to the Internet, intranets, Wide Area Networks (WANs), Local Area Networks (LANs), and transducer links such as those using Modulator-Demodulators (modems).

“Platform”, as used herein, includes but is not limited to a computing system that combines hardware and software, including application frameworks. The platform may include a computer architecture, operating system, programming languages, and related user interfaces, including run-time system libraries and/or graphical user interfaces. Providing a “platform as a service” (PaaS) is a category of computing services that may provide an integrated platform with specific application solutions as a service, with various levels of scalability. Services may include providing specialized and/or customized hardware, such as, for example, networks, servers, storage, interface devices, etc., and software, such as, for example, applications, interfaces, security, etc. Hardware and/or software associated with the services may or may not be dedicated to one platform. Providing a PaaS may include development, testing, deployment, hosting, maintenance, updating, etc. A PaaS may include the capability to integrate with various outside and/or private systems, such as, for example, web services, databases, and networks, utilizing, for example, Simple Object Access Protocol (SOAP) and Representational State Transfer (REST) interfaces.

“Signal”, as used herein, includes but is not limited to one or more electrical signals, analog or digital signals, one or more instructions, a bit or bit stream, or the like. The term “command” is synonymous with “signal.”

“Software”, as used herein, includes but is not limited to one or more computer executable instructions, routines, algorithms, modules or programs including separate applications or code from dynamically linked libraries for performing functions and actions as described herein. Software may also be implemented in various forms such as a stand-alone program, a servlet, an applet, instructions stored in a memory, part of an operating system (OS) or other type of executable instructions. It will be appreciated by one of ordinary skill in the art that the form of software is dependent on, for example, requirements of a desired application, the environment it runs on, and/or the desires of a designer/programmer or the like.

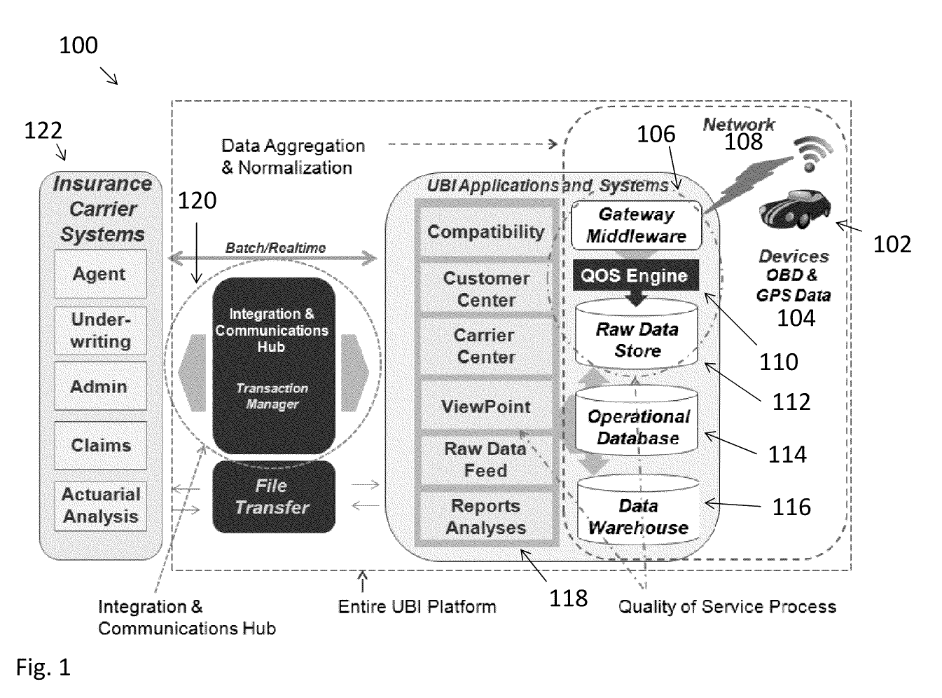

FIG. 1 shows an exemplary insurance support/enhancement platform 100, including exemplary hardware and software elements supporting carriers providing insurance, including, for example, usage-based insurance (UBI). As used herein, UBI includes usage-based insurance, behavior-based insurance (BBI), and other incentive or discount based insurance programs that may include use and behavior based elements including, for example, mileage, trips, driving performance and habits, geospatial data, etc. In other embodiments, the platform 100 may be associated with a driving performance product or application applicable to commercial/fleet management and self insurers. Clients of the platform or driving performance product may include insurance carriers, such as UBI cariers, commercial/fleet managers, self insurers, etc.

Insurers, for example, may be property/casualty insurance carriers that may use a driving performance product, such as a UBI product, for personal lines of insurance or commercial lines of insurance. Self-insurers, for example, may be companies with a large fleet that may self-insure an underlying layer of risk and may buy an umbrella layer of coverage over the self-insured layer. Self-insurers may use a driving performance product, such as a UBI product, that will allow them to gather the same data on drivers that an insurer tracks. Fleet managers, for example, may be companies with fleets of commercial vehicles and may have commercial insurance with a company that may not offer UBI, but they may be eligible for a discount from their insurance carrier if they employ a driving performance product, such as a UBI product, to monitor their drivers' performance. In other situations, fleet managers may use a driving performance product, such as a fleet management product (e.g., a subset of a UBI product), with features that allow them to track location, fuel consumption, hours of vehicle operation, etc.

A UBI product is an exemplary driving performance product. For simplicity, this application may refer to exemplary UBI products, programs, systems, features, transactions, etc. However, references to UBI are exemplary and include all of the exemplary driving performance products described above, among others.

In the exemplary platform 100 of FIG. 1, data, such as, for example, latitude/longitude of a vehicle 102 is captured and/or transmitted, for example, wirelessly from a device 104, associated with the vehicle 102, such as a dongle device, on-board diagnostic (OBD) device, global positioning system (GPS) device, iOS or Android device, smart phone, tablet, or other telematics device to one or more gateways 106 via, for example, network 108. The data from the device 104 may include information associated with driving performance related to, for example, a UBI product, such as, for example, driving behavior, vehicle location, etc. In some embodiments, data captured and/or transmitted by the device 104 may include data from more than one data source or device. For example, the device 104 may transmit data captured from the vehicle 102 OBD device and/or data captured from a GPS system included in the device 104. Gateways 106 may include a device 104 manufacturer's or provider's gateway or a common gateway established for the platform 100. In some embodiments, data may be captured and/or transmitted directly from the vehicle 102, such that the vehicle 102 or a component of the vehicle 102 is the device 104. The device 104 may or may not be connected to the vehicle 102. Data aggregation and normalization can occur using, for example, systems and methods described in U.S. provisional patent application Ser. No. 61/744,755, filed Oct. 3, 2012, and incorporated herein by reference in full.

Data may be processed through a Quality of Service (QOS) application or engine 110, which can evaluate, for example, data packets and aggregated packets (e.g., trips) and can pass results through algorithms for data retention, display, and/or use. QOS can assign measures of suitability and reliability to the data for analytical purposes. Resulting raw data can be stored in raw data store 112 and passed to an operational database 114 and data warehouse 116, which may allow some applications 118 (e.g., Carrier Center, Customer Center, ViewPoint, etc.) to access the data directly and/or other applications (e.g., Actuarial Analysis) to access the data via, for example, File Transfer Protocol (FTP). Access to aggregate data from multiple carriers and multiple device types may be granted for actuarial analysis by a carrier that contributes some but not all of the data. For example, Carrier #1 may deploy Device A and Device B in its UBI program, while Carrier #2 may deploy Device B and Device C. After the QOS process, the aggregate data from all devices is stored in data warehouse 116. Rules-based permission may allow Carrier A to access and analyze aggregate data from Device C, even though that device is not part of its program. This data enhances the actuarial analysis if it increases the overall quality of the data, i.e., its reliability. An integration and communications hub 120 can manage transactions to and from other systems and applications, including, for example, the exemplary insurance carrier systems 122. These communications and transactions may include, for example, logistics for ordering the device 104, dashboards for viewing driving results as recorded by the device 104, processes for managing insurance rates, etc.

Together, many of these components may be a part of a system and/or process for an integrated driving performance product, such as, for example, a UBI platform. In particular, the features mentioned in the following applications, which are incorporated by reference herein in full: U.S. provisional application Ser. No. 61/749,600, U.S. application Ser. No. 13/835,381, U.S. application Ser. No. 13/837,955, U.S. application Ser. No. 13/839,681, and U.S. application Ser. No. 13/841,203. Integrating various components of the driving performance product platform 100 with external and/or private systems can result in a platform that may be offered as a service, for example, to insurance carriers that want to quickly engage in a product, such as, for example, UBI, without developing the capability organically or internally. Essentially, the driving performance product platform 100 provides a “turn-key” platform that can integrate with existing systems, transforming them into a system capable of offering the product to customers. For example, offering a UBI platform as a service (PaaS) may allow an insurance carrier to expedite launch of an enterprise UBI initiative and facilitate ongoing UBI program management. This platform can harness the power of cloud computing and insurance technology expertise to deliver production-ready, compliant product administration. The platform's system architecture can be device 104 and network 108 agnostic, highly scalable, modular, transparent, supportive of hosting and business process outsourcing, etc. The platform can cover, for example, device 104 management, data management, QOS processes, transaction management, and data feeds to user applications. The PaaS may be offered to platform customers, such as, for example, insurance carriers or providers, by a platform administrator or integrator. For example, the UBI in a Box™ platform is a PaaS offered by The Evogi Group. Some embodiments of the PaaS may also be applicable to commercial/fleet management and self insurers, as discussed in more detail below.

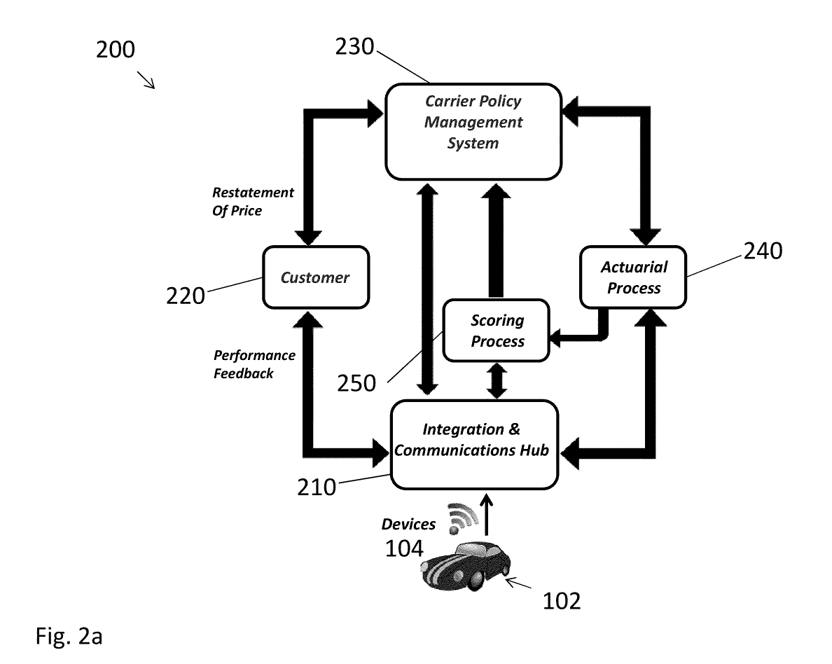

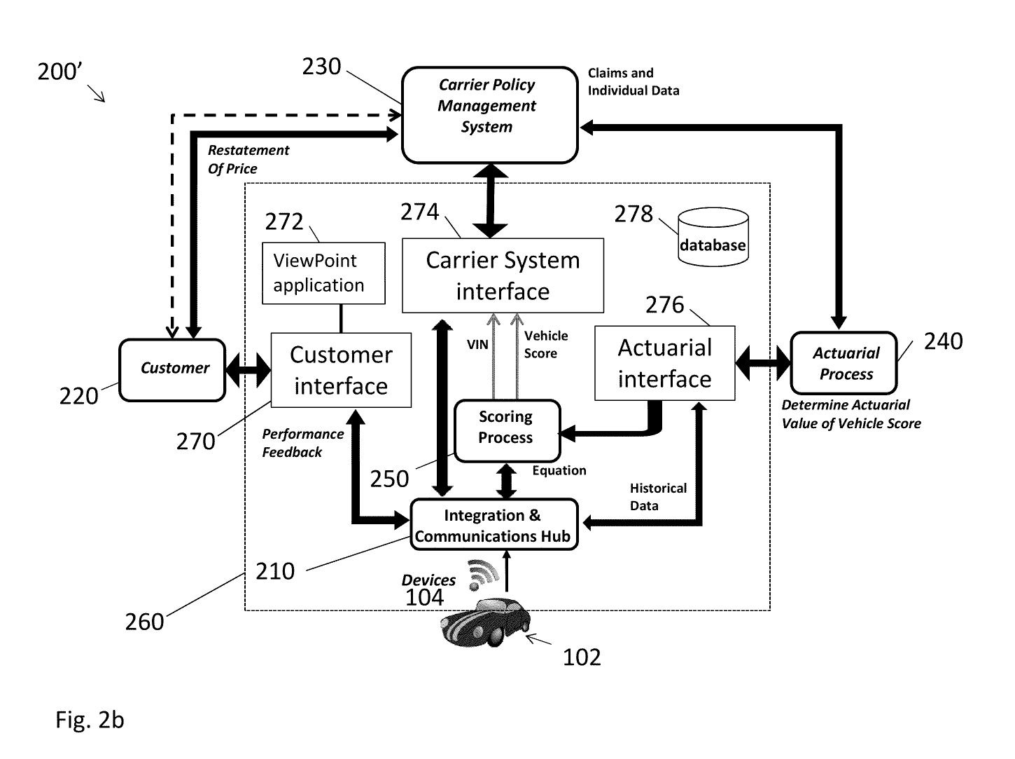

FIG. 2a depicts an exemplary insurance platform 200 that integrates various components of the exemplary insurance platform 100 with native insurance-based systems. The combined insurance platform 200 may include various hardware and software components capable of implementing the functions described below. All of these components may be integrated into one or more platforms in such a manner that allows the insurance platform 200 to seamlessly provide a product, such as UBI, as a service. For example, in this embodiment, the insurance platform 200 shows an exemplary vehicle 102 including an exemplary device 104 communicating data to an exemplary integration and communications hub 210. In some embodiments, the integration and communications hub 210 may include or be a part of all or portions of the UBI applications and systems from insurance platform 100 and may also include all or portions of the integration and communications hub 120 from insurance platform 100, as shown in FIG. 1.

The insurance platform 200 may also include applications that can interface with, for example, users and other systems. These may include, for example, a customer 220, a carrier policy management system 230, and an actuarial process 240. As part of the actuarial process 240, data is analyzed in order to predict the relative likelihood that a claim will be filed by members of a certain group, for example, drivers between the ages of 21-25. Based on historical data, the relative expectation of a claim being filed for this group is calculated and compared to all other groups. A rating factor may be assigned to the variable (age 21-25). That factor can be combined, for example, in an additive or multiplicative manner, with rating factors for other rating variables, such as, for example, gender, marital status, number and type of traffic accidents, zip code, type of car driven, and driving performance. Based on the actuarial process 240, insurance rates, discounts, and surcharges may be calculated. The customer 220, the carrier policy management system 230, and the actuarial process 240 may be specific to the product offering or may be common with other insurance-based products or systems. Exemplary customers 220 include policy holders of carriers. An exemplary function of the carrier database 230 is a restatement of price or rate quote issuance (RQI), including, when the carrier calculates and sends a quote for a new rate at renewal or mid-term if there is a policy change. In some embodiments, the carrier policy management system 230 and the actuarial process 240 may be included in one system, such as, for example, an integrated insurance carrier system or platform. The insurance platform 200 may also include a scoring process 250, as described in more detail below. In some embodiments, the scoring process 250 may include or be a part of all or portions of the UBI applications and systems from insurance platform 100 and may also be associated with all or portions of the integration and communications hub 120 from insurance platform 100, as shown in FIG. 1. As shown in FIG. 2a, the various components of the insurance platform 200 can communicate with each other to exchange data and information, in addition to the communication arrows shown in FIG. 2a. Also shown in FIG. 2a, the components can also cooperate with each other to provide user services, such as, for example, performance feedback and restatements of policy prices.

FIG. 2b depicts another embodiment of an exemplary insurance platform 200′ that also incorporates various components of the exemplary insurance platform 100. Exemplary insurance platform 200′ includes an exemplary PaaS, shown as platform 260, which may include one or more applications associated with the platform 260. For example, the platform 260 can represent exemplary components and/or systems of a UBI PaaS, which can be used to facilitate providing UBI to customers 220. The insurance platform 200′ may include various hardware and software components similar to those of the insurance platform 200 from FIG. 2a, but the platform 260 includes various interfaces capable of interfacing with systems and/or users external to the platform. For example, in this embodiment, the platform 260 includes, for example a customer interface 270, an application for QOS and Web analytics (e.g., ViewPoint application 272), a carrier system interface 274, and an actuarial interface 276. Other embodiments may include various combinations of these interfaces or additional interfaces.

These interfaces allow the platform 260 to integrate and/or interface with native entities, such as, for example, vehicles 102 via devices 104 and the integration and communications hub 210, customers 220 via the customer interface 270, an existing carrier policy management system 230 via the carrier system interface 274, and an existing actuarial process 240 via the actuarial interface 276. In this manner, the platform 260 provides a “turn-key” platform that can integrate with existing systems, transforming them into a system capable of offering the product to customers. These interfaces may include, for example, user interfaces, individual APIs, a framework of APIs, function calls, or any other logic to facilitate interfacing with systems or users external to the platform 260. The platform 260 may also include database 278, which may include or be a part of all or portions of the databases included in the UBI applications and systems from insurance platform 100, as shown in FIG. 1. The database 278 may be utilized by any of the components and/or systems of the insurance platform 200′, including the platform 260, to store data.

In another embodiment, carriers may choose to utilize the platform 260 for various communications other than those associated with the product, including utilizing the platform 260 as a single point of communication for the customer 220 regarding all of their activities with the carrier, via the customer interface 270. For example, the restatement of price may be communicated to the customer 220 via the platform 260 and the customer interface 270. However, in this embodiment, communications can still occur between the customer 220 and the carrier outside of the platform 260, including, for example, for items not associated with the product. FIG. 2b shows a dotted line between the customer 220 and the carrier policy management system 230 for these types of communications, i.e., for example, when the restatement of price occurs through the platform 260.

These interfaces allow for communication and data transfer between all of the components and systems of the insurance platform 200′, including through the platform 260. In one embodiment, the customer interface 270 may be, for example, a user interface for login of customers 220. Customers 220 may be able to access information associated with their products from the platform 260. In other embodiments, the login may be a “single login” that can facilitate access to information associated with any other insurance products or accounts associated with the customer 220, which may include non-UBI products. In other embodiments, the carrier system interface 274 may facilitate specific interactions. For example, the carrier policy management system 230 may communicate with the compatibility server (e.g., as shown in FIG. 1) of the platform 260 before a quote is started, to determine whether a compatible device 104 is available for the potential customer's vehicle 102. In another example, the carrier policy management system 230 may communicate with the integration and communications hub 210 of the platform 260 when the driver enrolls a vehicle 102 and the integration and communications hub 210 manages the enrollment process through the steps of sending the order to a third party and sending confirmation to the carrier policy management system 230. In other embodiments, the actuarial interface 276 may, for example, utilize FTP, export data into csv (comma separated values) files, store them on S3 (Amazon's cloud storage), and allow carriers to download them.

In other embodiments, a commercial auto platform may include all of the elements of the exemplary personal auto platform 260 and additionally may offer, for example, a driver behavior management application, a customer fleet management portal, and/or data management for risk classification and risk management. The data structure may include account management, shipping and billing information at the driver and account level. The commercial auto platform may also be provided by a platform integrator. For example, in one embodiment for commercial auto, the product may be configured for 1-4 vehicles, as provided, for example, by The Evogi Group. In another embodiment, a fleet management product may be configured for fleets of 5-99 vehicles, and is also provided, for example, by The Evogi Group. Features of an exemplary commercial auto platform may include “At a Glance Vehicle Scores” and risky event monitoring, basic vehicle trend analysis with comparisons to other demographic groups, detailed trip and event metrics with daily and weekly summaries, single vehicle at a time mapping of vehicle routes and risk events, easy user management (e.g., the ability to give drivers access to individual vehicle views), internet browser compatibility (e.g., Chrome, IE, Firefox, OSX), mobile browser support, and user configurable basic alerts and driver score distribution. In another example, features of another exemplary commercial auto platform may include real-time vehicle positioning, accident alerts (e.g., crash notification), support for device 104 with a buzzer, distracted driver integration (e.g., cell phone blocking applications triggered by GPS or OBD motion detection), vehicle 102 diagnostics (e.g., engine, seatbelts, airbag, etc.), and geospatial overlay (e.g., speed over posted speed limits, weather, road type, etc.).

As illustrated in this application, blocks or steps of flowcharts represent logic functions, actions and/or events performed therein. It will be appreciated by one of ordinary skill in the art that electronic and software systems involve dynamic and flexible processes such that the illustrated blocks and described sequences can be performed equivalently in different sequences or in parallel. It will also be appreciated by one of ordinary skill in the art that elements embodied as software may be implemented using various programming approaches such as, for example, machine language, procedural, object-oriented, or artificial intelligence techniques. It will further be appreciated by one of ordinary skill in the art that, if desired and appropriate, some or all of the software can be embodied as part of a device's operating system.

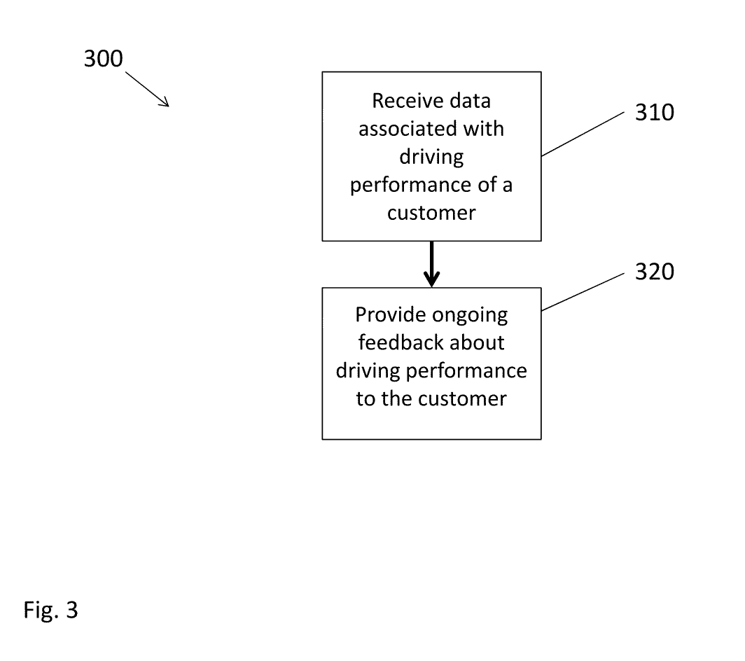

For example, with continued reference to FIG. 2b and additional reference to FIG. 3, the insurance platform 200′ can provide driving performance feedback to a user, such as customer 220, according to process 300. Starting at 310, device 104 data associated with vehicle 102 may be received by the integration and communications hub 210. At 320, ongoing feedback about driving performance may be provided directly to the customer 220 via the platform 260 and the customer interface 270. The customer interface 270 may be part of or include an application, such as, for example, the Evogi Customer Center, which is described in more detail below.

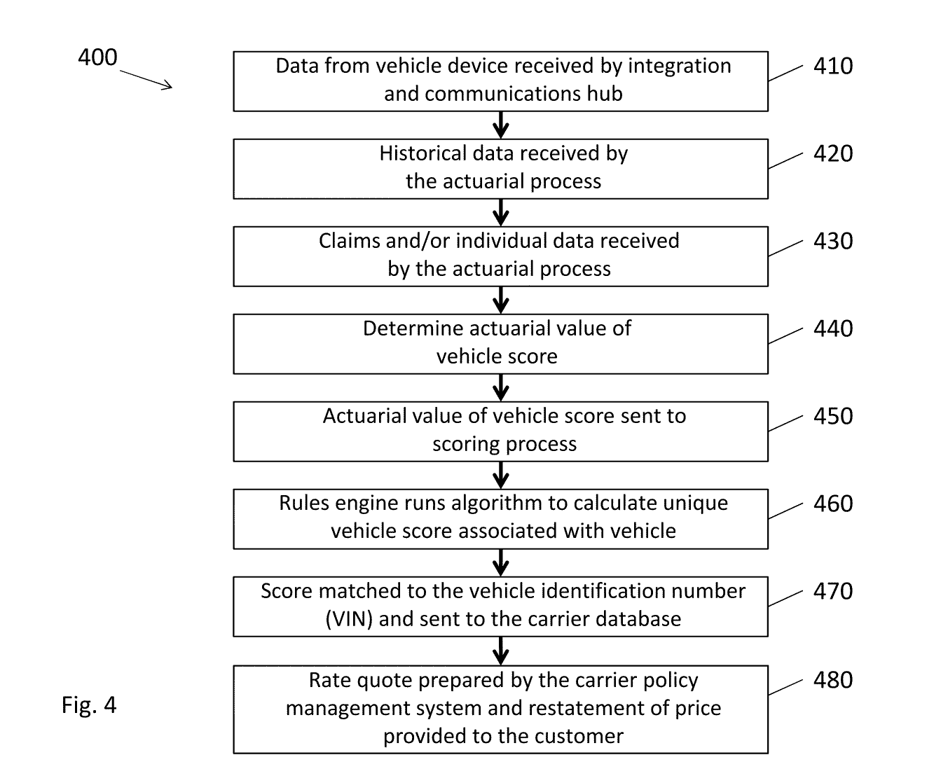

In another example, with additional reference to FIG. 4, the insurance platform 200′ can provide a restatement of price to a user, such as customer 220, according to process 400. Starting at 410, device 104 data associated with vehicle 102 may be received by the integration hub, and at step 420, sent to the actuarial process 240, which may be, for example, a platform integrator system (e.g., The Evogi Group system), insurance carrier system, and/or third party system, through, for example, secure FTP, and/or from the integration and communications hub 210. At step 430, claims and individual data are available to the actuarial process 240 through, for example, secure FTP, from the carrier database 230.

At step 440, the actuarial process 240 determines an actuarial value of a vehicle score. In other words, for example, the actuarial process 240 can determine how much or how little a vehicle score will be worth when a new rate is calculated based on the driving behavior. At step 450, the actuarial value of a vehicle score is sent to the scoring process 250. At step 460, a rules engine of the scoring process 250 runs an algorithm or equation that determines or calculates a unique score associated with the vehicle 102. At step 470, the vehicle score is matched to the vehicle identification number (VIN) and sent to the carrier database 230. At step 480, a rate quote is prepared by the carrier database 230 and a restatement of price may be offered directly to the customer 220. However, as mentioned above, in another embodiment, the restatement of price may be offered to the customer 220 via the platform 260 and the customer interface 270. The restatement of price may be higher or lower than the previous price, based on various factors, including the vehicle score.

For example, the integration of the UBI applications and systems with the carrier's actuarial and policy management environments, for example, as a UBI PaaS, as shown in the exemplary insurance platform 200′ of FIG. 2b, can allow an insurance carrier to quickly implement an enterprise UBI initiative by simply utilizing the services provided by the UBI PaaS and the functionality of the UBI platform 260. Additional characteristics and features of the UBI platform 260 include: an “open” architecture that can allow change, re-use, and extensibility; a standards-based system that includes, for example, standard messaging protocols, schemas, integration patterns, etc.; integration with other business systems; a “Fit For Purpose” approach, where each application is responsible for appropriate functions; use of automation, such as, for example, use of workflow, orchestration, minimal manual tasks, etc.; a customer centric approach where the customer 220 is the first priority, including, for example, identification, experience, touch points, etc.; configurable systems that include, for example, the capability to change settings and not necessarily code (i.e., code can be prepared for all scenarios initially); real time or near real time flow of data and information; and single login for users, for example, customers 220 and carrier personnel.

An exemplary UBI platform 260, embodied as a UBI PaaS, such as the UBI in a Box™ platform offered by The Evogi Group, can offer UBI as a service to implement UBI for a carrier, facilitate ongoing UBI program management, and support the carrier or risk manager. For example, the carrier may need support in change management as a result of embarking on utilizing driving usage or behavioral data for business optimization purposes. Leveraging telematics in insurance, for example via a UBI PaaS, may result in significant organizational changes that can provide benefits beyond pricing segmentation, including, for example, the reduction of loss and loss costs and access to distinctive value-added services.

The UBI as a service approach, including, for example, UBI PaaS, can harness the power of cloud computing and insurance technology expertise to deliver production-ready, compliant UBI administration. Utilization of a UBI PaaS can be the most efficient, e.g., shortest, fastest, and most direct, route to implementation of a UBI program.

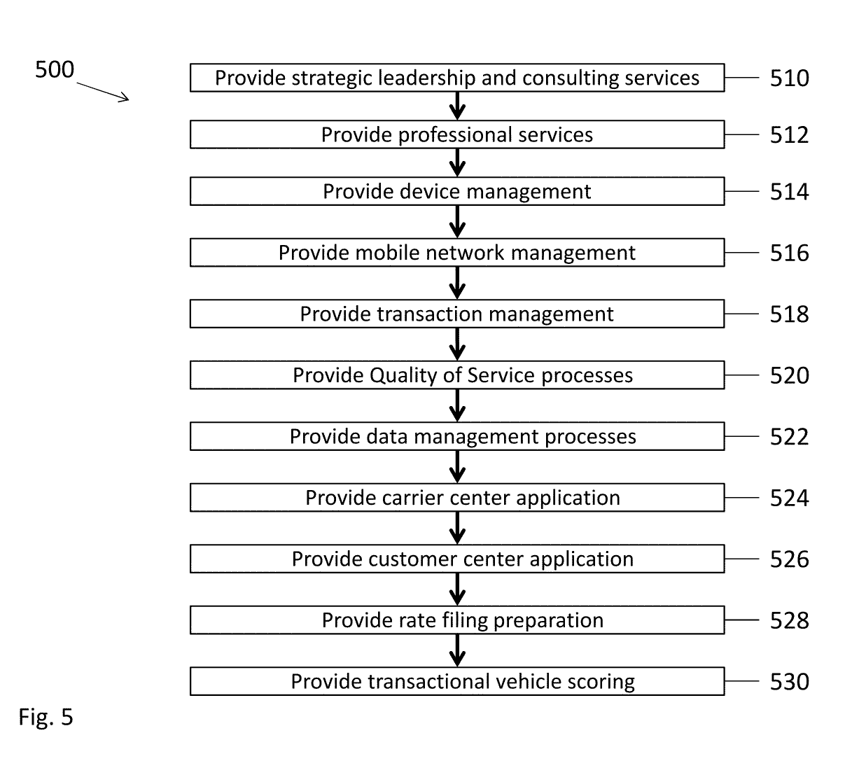

For example, a platform 260, embodied as a UBI PaaS, such as the UBI in a Box™ platform offered by The Evogi Group, can facilitate providing one or more of several services, processes, applications, and/or products according to an exemplary PaaS implementation process 500, as shown in FIG. 5. The PaaS implementation process 500 may utilize the exemplary insurance platform 200′ and platform 260, as shown in FIG. 2b, including processes 300 and 400, shown in FIGS. 3 and 4, respectively. In particular, for example, referring to FIG. 5, step 510 provides strategy leadership and consulting services for product design and systems. Step 512 provides professional services, including, for example, program management, project planning, development, implementation, testing, training, change management, filing support, transactional scoring, etc. At step 514, device 104 management is provided for telematics or mobile devices, including, for example, device 104 selection, compatibility, availability, and functionality methodologies. Step 516 provides mobile network 108 management that can handle, for example, mobile network 108 connectivity, data transport to/from devices 104, gateway 106 services, reliability, etc. At step 518, transaction management is provided, which can work through the integration hub to handle the flow of raw data through Enterprise Resource Planning (ERP) systems to the communications hub and external vendors, for full customer lifecycle management.

Continuing to step 520, QOS processes are provided, including, for example, dashboard and system metrics that can ensure data accuracy and integrity for carriers, drivers, vendors, original equipment manufacturers (OEMs), etc. Step 522 provides data management processes that can facilitate manipulation and analysis of data to create highly actionable information. Step 524 provides a carrier center application that can provide a comprehensive customer support tool, for example, for provisioning and case management and where carriers can be supported with levels 1-3 technical support. Step 526 provides a customer center application that can include, for example, displays of vehicle 102, driver, and driving data, as well as, for example, the logistics and online or mobile application for device 104 fulfillment and de-activation. At step 528, rate filing preparation is provided for insurance department approvals, including, for example, initial data analysis and preparation of a vehicle score, such as, for example, the formulation of the actuarial value of a vehicle score, completion of initial filing, and analysis and filings based on inbound data from active program. At step 530, transactional vehicle scoring is provided, which can include, for example, managing the transactional integrity of data and the implementation of scoring. As mentioned above, the scalability of the platform 260 and the PaaS implementation process 500 allows for the incorporation, integration, and utilization of any number of combinations of these services, processes, applications, and products. Individual steps may be added or deleted, may be performed in any order, may be combined and executed together, and/or may be executed in parallel. Different embodiments of platforms 260 and PaaS implementation processes 500 may include any and all combinations of these services, processes, applications, and products, which are discussed in more detail below.

Strategy Leadership and Consulting Services 510

Insurance and telematics experts can provide leadership and direction for business strategy and market entry, product design, customer communications, systems implementation, etc.

Professional Services 512

Providing professional services can ensure the successful delivery of a carrier's program launch. Platform 260, embodied as a PaaS, can include deliverables, such as, for example: program governance structure; an aggregate program plan; defined work management processes and procedures; management of the program level, consolidated processes, including, for example, work management, case management, project management, project billing and accounting, time tracking, etc.; management of the program change review board; management of program and product model requirements gathering, documentation, and test cases; creation and management of the release management process; management of systems integration testing and final user acceptance testing (UAT) sign-off; and management of all insurance company tactical integration requirements.

Device Management 514

The telematics devices 104 and the data produced by them are a foundation of the platform 260, including when embodied as a PaaS. A device integrator/manager, such as, for example, The Evogi Group for the UBI in a Box™ platform, can routinely evaluate device 104 manufacturers and select the best devices 104 for integration into its product offering. This activity may include determining device 104 and vehicle 102 compatibility. For example, the device integrator may create a partnership with multiple device 104 manufacturers to be able to support device 104 compatibility with the largest number of vehicle 102 year, make, model, and engine type combinations.

As part of the customer 220 enrollment process, customer data can be sent from the integration and communications hub 210 to a compatibility server (e.g., as shown in FIG. 1), which can return either a device 104 order or a non-compatibility message. The device manager can provide devices 104 to customers 220 in carrier-branded packaging. The compatibility server can include a rules engine and algorithms for matching devices 104 to vehicles 102, based on probabilities calculated from analysis of success rates by VIN. Factors that may be considered include, for example, engine size, ergonomics (e.g., position and/or location of device 104 under dashboard), etc. In particular, there may be variations in the formats of device 104 connection pin-outs. For example, OBD pin ports can have at least five variations/protocols. In some embodiments, the carrier or customer can be alerted to possible ergonomic issues that may limit the use of a device in a particular vehicle.

The compatibility server can include a compatibility database with various types of compatibility data loaded. For example, the compatibility data may include device 104 manufacturer data about the compatibility of their device 104 for a specific vehicle 102, based on OBD pin port layout, engine size, diesel/electric, etc. In many cases, manufacturers may label devices 104 compatible for the same vehicles 102. As part of device management, rules may determine the best match by vehicle 102 and can continuously updates this designation based on other data (including, e.g., testing, customer feedback, and returns). The compatibility server may be accessed during the carrier's quote process. If there is not a compatible device 104 for the vehicle 102, the quote process may be stopped. If the device 104 issues are related to ergonomics, a carrier may establish a rule to allow or disallow a particular device 104. An alternative approach to accessing the compatibility server during the quote process is to provide access to a web-based compatibility checker. For example, a general agent or self-insurer could check device 104 compatibility outside of a carrier's quoting process. An agent portal may be provided to support “pre-enrollment” activities. For example, an agent may look up compatibility by vehicle make, model, year, and engine type or by VIN. The portal can query the database directly.

In addition, the compatibility data may also include ergonomic data collected by the platform integrator's testing, including, for example, for bad data port locations that cause the device to interfere with proper or safe use of the vehicle. The compatibility data may also include customer 220 feedback or complaints about installation difficulty, dislodged devices 104 due to port or device 104 issues, etc. The compatibility data may also include data associated with devices 104 returned for installation or performance failures.

The device integrator may also manage functionality capability issues. For example, competing device 104 manufacturers, such as, for example, OBD II manufacturers, may continually “leapfrog” one another to achieve market leadership. By partnering with these manufacturers, the device integrator can introduce continuous improvements and capabilities at rates that exceed competitors in the industry. In addition, working with multiple manufacturers may ensure that device 104 availability never hinders an insurance carrier's need to meet demands arising from increased levels of customer 220 or policyholder adoption.

Device management may also include proactively managing all firmware requirements, device 104 updates, and technical fixes to provide the highest reliability, increased device 104 longevity and usefulness, widest telematics program support, and best customer 220 experience. The device manager can push firmware updates wirelessly (over-the-air) to extend device 104 life and usefulness while maximizing use time. The device manager can also take advantage of the typically declining cost of devices 104 when they occur. In this manner, the device manager can drive program costs down over time for insurance carriers.

Mobile Network Management 516

Providing mobile network management can include establishing mobile network connectivity with various mobile service providers, for example, phone and data, carriers to ensure successful data transmission from devices 104 through the network 108. The network manager may also assess data transport to/from devices 104 and return unacceptable transmissions, establish gateway services for data transfer from mobile carriers to gateway 106, and ensure reliability of data through QOS processes. Data transmission cost from devices 104 can also be managed through the employment of techniques such as program specific reporting profiles, data cleansing, event driven burst transmissions, and data compression to ensure that only relevant data is transmitted as efficiently as possible.

Transaction Management 518

Providing transaction management may include integration of items of information from the telematics or mobile device 104 associated with a vehicle 102 to a carrier's systems for insurance program management and the return of items of information for communication via the device 104, based on customized program rules.

Insurance transactions managed by the data integration and communications hub 210 may include, for example: device 104 installation for program enrollment; policy and participation changes; rate changes; actuarial analysis, risk assessment, and data modeling; loss reporting, accident alerts, and claims management; customer 220 education and other game-based interactions. These transactions can be processed in real-time, batch mode, or with delayed effective dates.

Processes supported by the integration and communications hub 210 may include, for example: acquiring, synchronizing, and loading raw, real-time or near real-time, data from a wide range of telematics or mobile devices 104 into the data integration and communications hub 210; cleaning, verifying, de-duping, and enriching data; a rules-based, carrier-branded communications system that can deliver customized messages to the customer 220 and that can create diarized activities for follow-up; carriers that have the ability to manage customer 220 transactions across disparate internal systems, including mainframe and web-based systems for policy service, claims, and analysis; and accessing data through a single sign-on, rules-based portal available to carriers, customers 220, agents, fleet managers, etc.

Quality of Service (QOS) 520

Providing QOS can include a method for determining the likelihood that a packet of information transmitted by OBD II or other telematics devices 104 meets user requirements for accuracy, reliability, and quality of data, and that is suitable for implementation and modification of a UBI or self-insurance program. Additionally, methods may be established for determining when and how to display data to each constituent, including policyholders (e.g., customers 220), insurance actuaries, and insurance carrier personnel, such as, for example, customer service staff.

For example, after data aggregation and normalization, each packet of information can be subjected to rules/algorithms for accuracy, reasonability, and fraud detection. Data may be labeled, for example, as Ideal, Flagged with Explanation, or Flagged Unreliable. Further rules can determine how data is displayed, for example, as received, as corrected and displayed with minor modifications, as retained and flagged as questionable, or as retained and flagged as unreliable. More detail is provided in U.S. application Ser. No. 13/839,681, incorporated by reference herein in full.

Rules can exist for a wide range of conditions, including, for example: Point-to-point travel—using GPS coordinates, QOS can determine, for example, whether a vehicle 102 traveled in a forward direction and/or whether it could reasonably have covered a certain distance within an elapsed time; Prior and current trips—comparing packets that were sent earlier, QOS can assess the reasonableness of the current location and current trip vis-à-vis a prior trip and prior location; Vehicle 102/Device 104 mismatch—QOS can compare the device 104 registered to the vehicle 102 enrolled in the program or insured by the carrier, retain data from mismatched vehicles 102/devices 104, and subject the data to other QOS processes, including, for example, reporting the mismatch to the carrier for further action; Tampering/Disruption of signal—QOS can compare the date and time of prior packets as well as current and prior global positioning system (GPS) coordinates to find gaps in data transmission that may indicate a malfunctioning or unplugged device 104, and if unplugged, QOS can report the interval since the last transmission, distance traveled, and frequency of occurrence; and Accelerometer data—the QOS algorithm can use multiple data packets to calculate metrics, for example, for cornering and braking. QOS processes can evaluate the reliability of the data before and after the calculations.

The QOS process can be based on various algorithms and analysis of data readings, ensuring quality of information, including, for example: GPS fix (2D or 3D); horizontal dilution of precision (HDOP) (positional accuracy); device 104 status; missing latitude and/or longitude; vehicle 102 idle; time, including, for example, whether valid, not valid, altered, etc.; GPS location comparison to previous reading, including, for example, duplicate, distance discrepancy, etc.; GPS speed, including, for example, whether correct, excessive, etc.; display in user interface (including, e.g., display_cloud=group with other locations, display_hide=do not use); etc.

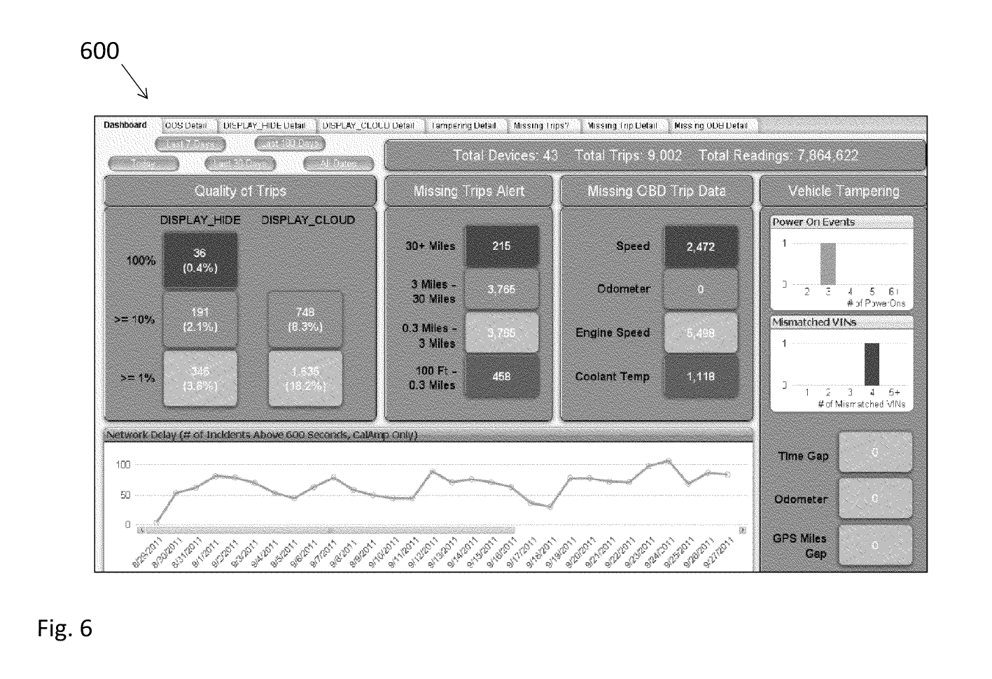

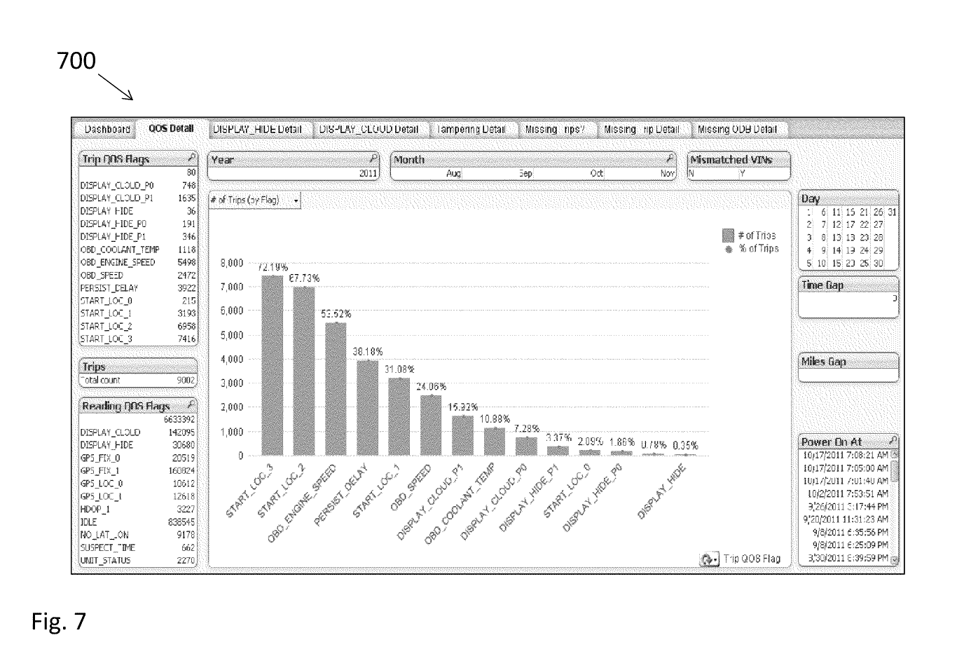

FIG. 6 shows an exemplary screenshot 600 from an exemplary QOS system showing various QOS attributes. FIG. 7 shows an exemplary screenshot 700 from an exemplary QOS system showing occurrences of various QOS flags.

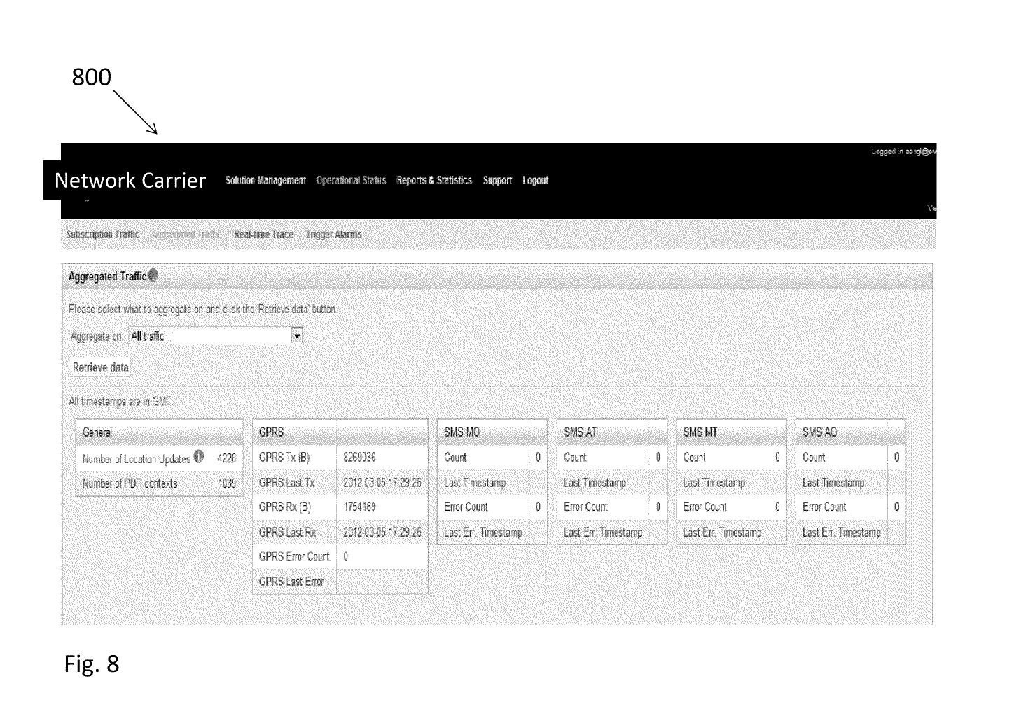

QOS may also include mobile network monitoring and automation of SIM card logistics. QOS can utilize a portal application to manage SIM cards and monitor network QOS. This can include, for example, providing the following functionality: Subscriber Identity Module (SIM) status; Application Programming Interface (API) integration; activate, suspend, and deactivate SIM's; monitor usage details, including, for example, packet data, Short Message Service (SMS), etc.; and network alerts and reports. FIG. 8 shows an exemplary screenshot 800 from an exemplary Mobile Network Portal, as part of a QOS system, showing various attributes of aggregated traffic data.

Data Management 522

Providing data management can include managing the use of information, for example, from the integration and communications hub 210. Data can be used by various systems, including, for example, insurance carrier systems and the UBI system itself. Data management can include, for example, data capture, data storage, and data analysis capabilities that can meet an insurance carrier's customer 220 experience and product development requirements initially and over time. The integrity of data captured after the QOS process can allow more granular event determination and iterative learning that facilitates finer segmentation.

Providing data management can include both infrastructure and products. Regarding infrastructure, data management can include, for example: data storage, scaling, and security; real time and batch feeds; reliability in the network 108 and applications; and data integrity. Regarding products, data management can include: data reliability and availability; rating, pricing, and underwriting variables, including, for example, speed, engine revolutions-per-minute (RPM), and location; vehicle 102 operations and dispatch, for example, for claims, fraud detection, etc.; analysis and categorization of events within a trip; data collection, aggregation, and normalization; transactional integrity of data and implementation of scoring; data augmentation and/or improvement, including, for example, weather, traffic, road surface, etc.; integration of policyholder underwriting and claims data; and First Notice of Loss (FNOL) algorithms may be developed from event data within a trip. For example, a hard braking event (e.g., a deceleration as measured by a device 104) above a certain threshold could be used to document a vehicle 102 accident by use of algorithms, such that the data is provided from the transaction manager to the insurance carrier's claims systems before the customer 220 notifies the carrier. FNOL may also be used for proactive incident response. For example, thresholds can be set at a level (e.g., 4G) that will minimize false positives, but alert based on events with a high probability of loss. More detail is provided in the following patent applications: U.S. application Ser. No. 13/835,381, U.S. application Ser. No. 13/837,955, U.S. application Ser. No. 13/839,681, and U.S. application Ser. No. 13/841,203, which are incorporated by reference herein in full.

Carrier Center 524

Providing a carrier center can include, for example, providing a cloud-based business management application that can provide, for example, immediate role and/or permission directed access for customer management, reporting, data access, etc. The carrier center may be configured to allow a customer service representative (CSR) to handle all account management functions on behalf of the customer 220 without interfacing with the carrier's policy management system, allowing the carrier center to be the primary management system for UBI transactions. Exemplary transactions can include, for example, customer management, device inventory management, bill reconciliation, management reports, and data access. The carrier system interface 274 (e.g., as shown in FIG. 2b) may be part of or include an application, such as, for example, the Evogi Carrier Center.

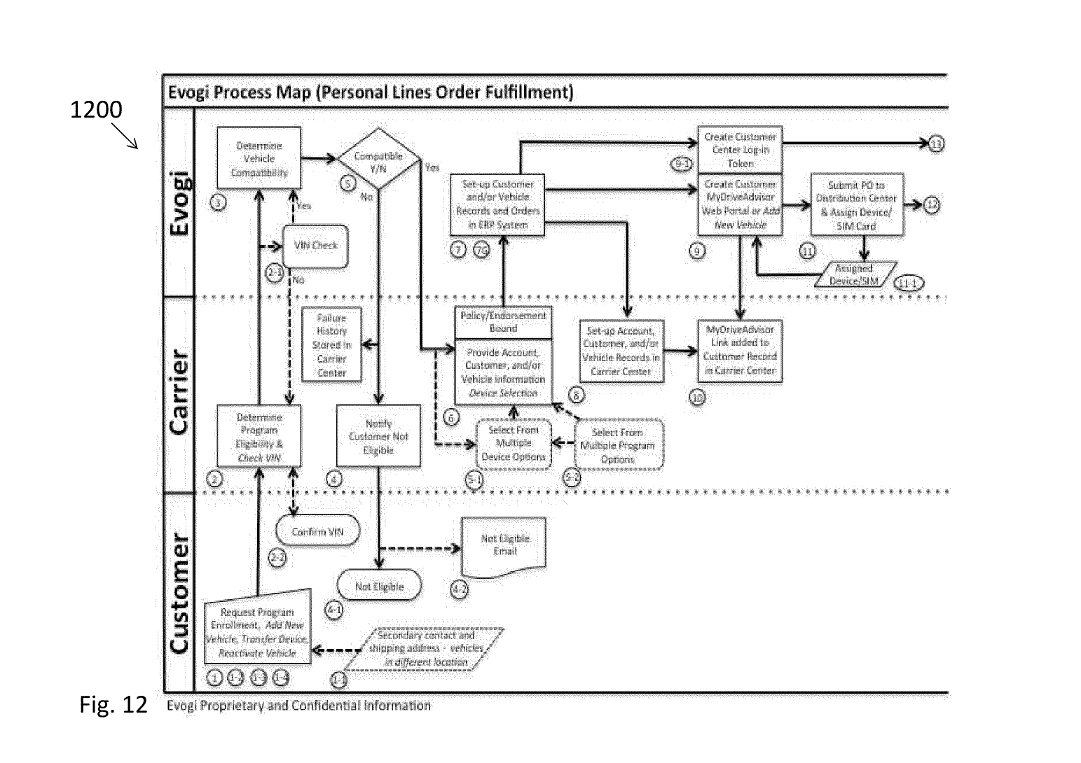

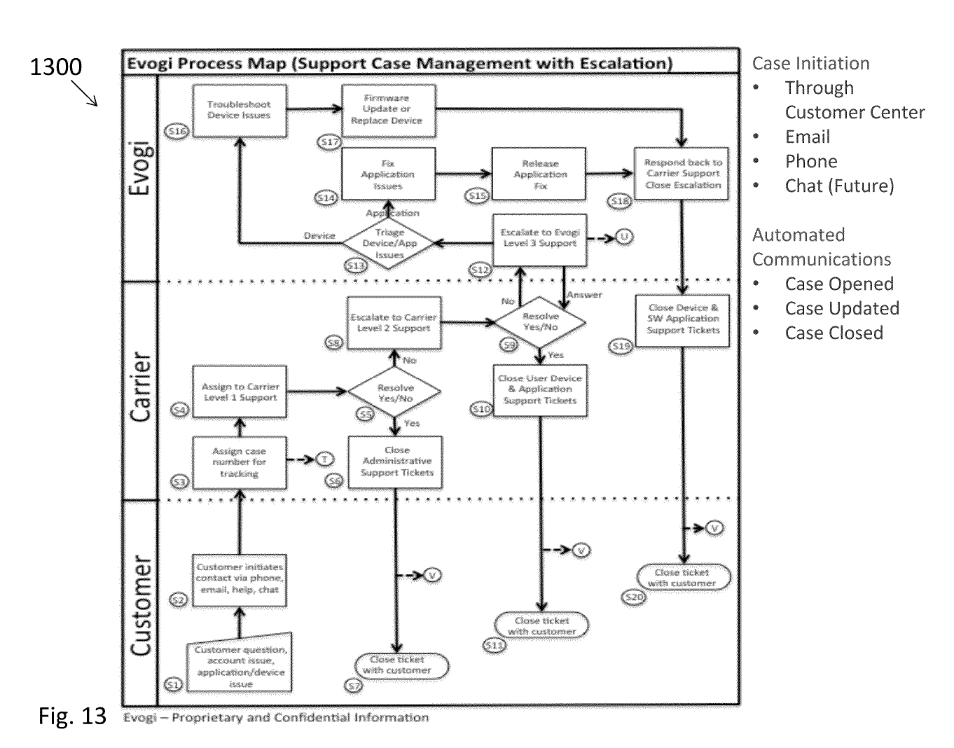

Customer management transactions can include, for example, customer set-up (see also the customer center, described in more detail below), vehicle 102 set-up, logistics around order entry and device 104 fulfillment (see, e.g., FIG. 12 showing a partial process map for order fulfillment) and return, and case management (see, e.g., FIG. 13 showing a process map for support case management with escalation).

Management report transactions can include, for example: a configurable dashboard; loss control, claims and underwriting reports; quotes and sales; vehicles 102; and cases. Data access transactions can include, for example, key performance indicator (KPI) reports and data downloads.

Level 1-3 technical support may be provided for the carrier center and systems as well as the telematics environment.

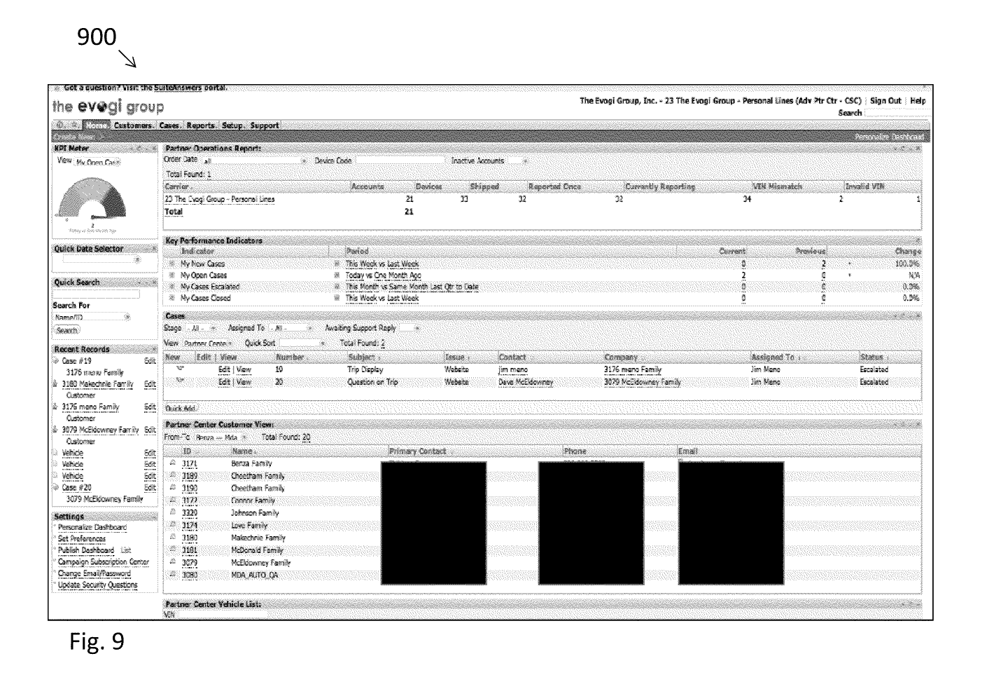

FIG. 9 shows an exemplary screenshot 900 from an exemplary carrier center application, showing various attributes, including KPIs. Additional screenshots are included in the Appendix.

Customer Center 526

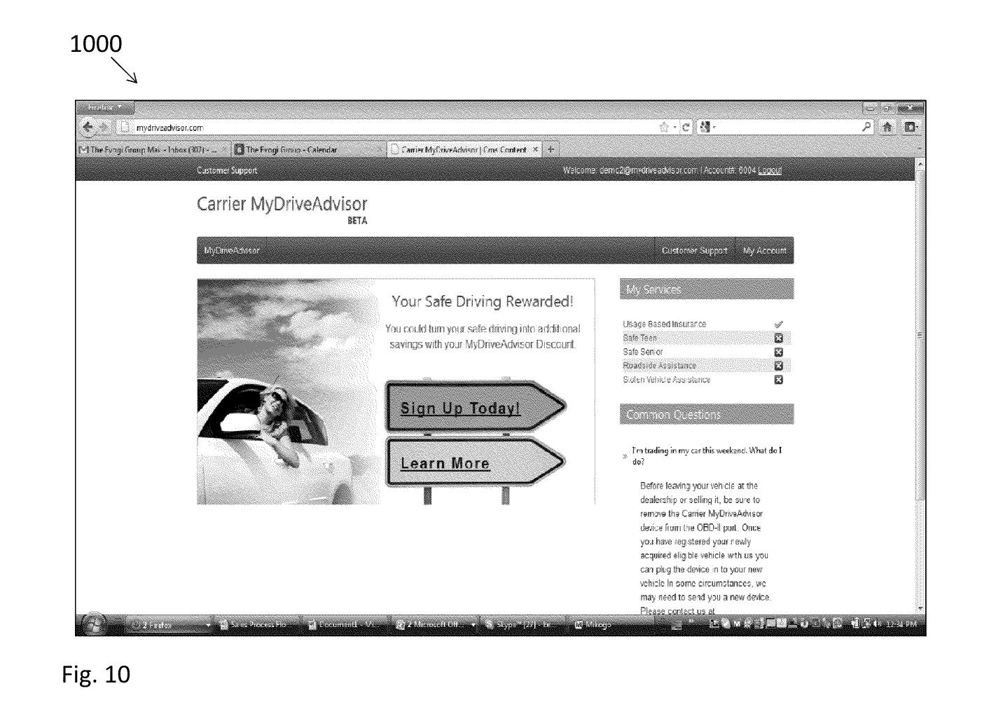

Providing a customer center can include providing a configurable, white label customer service solution, such as, for example, The Evogi Group's Customer Center, for allowing customers 220 to access information about a UBI product. FIG. 10 shows an exemplary screenshot 1000 from an exemplary customer center application. For example, the customer center can include: a Software as a Service (SaaS) customer center that can be private labeled or branded by a carrier or risk manager; seamless and transparent integration with a carrier's existing online or mobile platform, with functionality that can manage on-boarding (e.g., organizational socialization) and ongoing communications about UBI products; personalized account and password management and reporting for each customer 220; and frequently asked questions (FAQs) and support information to speed implementation and promote customer self sufficiency. As mentioned above, the customer interface 270 (e.g., as shown in FIG. 2b) may be part of or include the Evogi Customer Center.

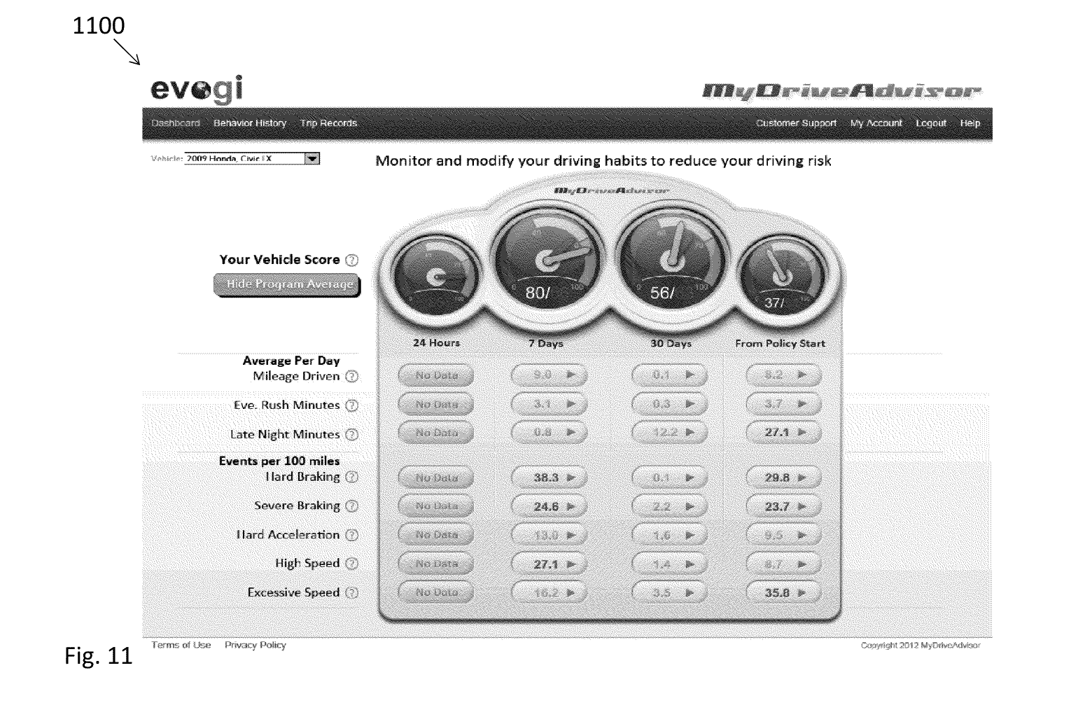

Additional functionality may be configured by a carrier and delivered via the customer center, including, for example: single sign-on for the carrier's existing system that may allow connection to the UBI customer center; presentation and acceptance of privacy policy and terms of use upon initial login; customer's 220 online acknowledgement and/or acceptance of data capture and use for insurance products; communication system that can deliver targeted, real-time messages about driving behavior, vehicle 102 performance, insurance rates and discounts, game and community results, etc., via, for example, online or text messages; integration with a gamification platform for providing game-based interactions; dashboard that can give the customer 220 an overview of their driving behavior and vehicle score for all vehicles 102; detailed historical view of driving behavior and metrics that can be coupled with driving behavior management reporting and tools associated with UBI products; integration point with carrier center for support services; value-add and location-based services, such as, for example, roadside assist, teen and senior driver monitoring and/or management; and integrated smart-phone applications. FIG. 11 shows an exemplary screenshot 1100 from an exemplary customer center application showing exemplary vehicle 102 scoring and driving behavior feedback.

Rate Filing Preparation 528

Providing rate filing preparation for insurance department approvals can include, for example, providing: initial data analysis and preparation of a driver score; completion of initial filing; and ongoing analysis and filings based on inbound data from an active UBI program.

Transactional Vehicle Scoring 530

Providing transactional vehicle scoring can include, for example: managing the transactional integrity of data; and implementation of a scoring model. Development of a vehicle score can include managing the transactional integrity of data, data preparation, analysis, and modeling. Data may include device 104 data only or may be enhanced with a carrier's historical or actual loss experience. Aggregate data from external sources may be used to augment data modeling efforts.

The exemplary PaaS implementation process 500, as shown in FIG. 5, and the exemplary platform 260, as shown in FIG. 2b, may utilize certain technologies for implementation. For example, the implementation process 500 and the platform 260 may include: an end-to-end solution that may include, for example, hardware, firmware, mobile networks, gateways, software stacks, various applications, etc.; multiple applications, including, for example, for consumer, carrier, and actuarial processes; multiple policy holder product applications, including, for example, for UBI, teen/senior, commercial, etc.; measured quality of data (QOD) and with feeds to actuarial processes; highly scalable SaaS solutions that can run in a cloud environment; and data security and privacy solutions.

In addition, the implementation process 500 and the platform 260 may include a state-of-the-art applications environment. For example, particular environments may include, for example: development; OS X and Linux Ubuntu; browser compatibility test; virtual machines (VM) provided, for example, by SauceLabs (e.g., Scout); automated browser compatibility; Mongotest; test/staging; 64 bit Ubuntu 10.04.3 Amazon Web Services (AWS) Instance; production; and 64 bit Ubuntu 10.04.3 AWS Instance.

Backup processes may include, for example, automated cron jobs that can do complete relational and document database backups nightly and backups can be stored in Amazon S3. Data recovery processes may include, for example: databases that can be backed-up nightly; backups that can be done more frequently since data import may be trivial; total recovery from data not backed up on S3 may not be completely clean, but may be possible; and multiple levels of buffering.

Health monitoring may include, for example; employing third party software (e.g., ICINGA) to monitor development, model office, staging, and production servers; monitoring processes, log staleness, and server responsiveness (periodic ping); monitoring frequency of messages received from devices 104, trips generated, readings processed, and messages put on queue; monitoring the middleware, databases, and Java memory usage via Java Management Extensions (JMX) hook; and monitoring overall server resources, including, for example, memory usage, disk storage, CPU usage, and network throughput.

The systems architecture associated with the implementation process 500 and the platform 260 may include non-functional attributes and/or features, such as, for example: scalability; reliability; no single point of failure; device 104 agnostic; network agnostic; RESTful; no vendor lock-in; maintainable and modular; and transparency, including, for example, for developer, system status, and diagnostics.

In addition to the embodiments above that include an exemplary UBI environment, the application is also well suited for other applications, including, for example, fleet management for commercial auto insurers and self-insurers. In these embodiments, certain parameters of the platform may be focused differently, such as, for example, the interfaces and scoring. However, a PaaS with the capability to track certain metrics, for example, associated with driver behavior and vehicles, for feedback and analysis may be very useful, for example, to determine and minimize risk.

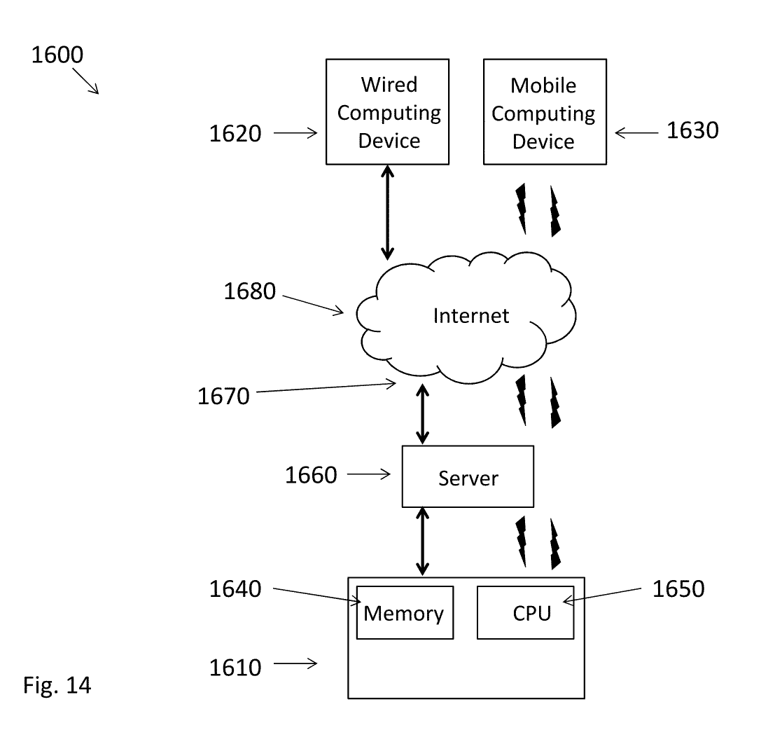

FIG. 14 includes an exemplary depiction of exemplary communication protocols and exemplary devices containing the exemplary insurance platform 200′, platform 260, and/or providing the PaaS implementation process 500. The devices can include the means for executing logic associated with the insurance platform 200′, platform 260, and/or providing the PaaS implementation process 500, and their associated applications. The platform and/or its associated applications may be accessed and/or stored via a variety of computing devices 1610, including, e.g., wired devices 1620 (e.g., desktop computers) and mobile devices 1630 (e.g., smartphones and tablets), kiosks, or any other device capable of hosting or presenting the platform and/or its associated applications to a user with a display and input mechanism. The platform and/or its associated applications may be stored in the memory 1640 of a device and processed by a Central Processing Unit (CPU) 1650. The platform and/or its associated applications and/or their associated logic may be stored and accessed via the same device, stored remotely in a first device and accessed via a different second device, or any other combination thereof. The platform and/or its associated applications may be stored in local or remote memory (e.g., of a server 1660), and accessible directly or via a network 1670 (e.g., over the internet 1680). The platform and/or its associated applications may also be a web-based application accessible via the internet 1680. A database associated with the platform and/or its associated applications may be located in the same or different memory location than the platform and/or its associated applications. Similarly, a database associated with the platform and/or its associated applications may be accessed the same way or differently than the platform and/or its associated applications.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the applicant's general inventive concept.

The following is claimed:

1. A method of providing a platform for a driving performance application, comprising:
receiving data associated with driving performance;
comparing the data to a driving performance standard;
calculating a score associated with the driving performance; and
reporting the score to at least one user.

2. The method of claim 1, wherein receiving the data associated with driving performance comprises receiving data from a device associated with a vehicle.

3. The method of claim 2, wherein the vehicle is associated with the user.

4. The method of claim 1, further comprising determining a vehicle identification number associated with the vehicle.

5. The method of claim 1, further comprising evaluating the data with an actuarial process.

6. The method of claim 5, further comprising sending the data to the actuarial process.

7. The method of claim 5, further comprising sending historical data to the actuarial process.

8. The method of claim 5, further comprising sending individual data to the actuarial process.

9. The method of claim 5, further comprising determining an actuarial value associated with the data.

10. The method of claim 9, further comprising combining the data with the historical data or the individual data to determine the actuarial value.

11. The method of claim 9, further comprising combining the score with the actuarial value.

12. The method of claim 5, wherein sending the data to the actuarial process comprises an actuarial system interface communicating with the actuarial process, and wherein the actuarial process is associated with the at least one user.

13. The method of claim 1, further comprising providing an insurance rate to a customer, wherein the insurance rate is based on the score.

14. The method of claim 13, wherein providing the insurance rate to the customer is via a customer interface of the platform.

15. The method of claim 1, wherein the user is at least one of an insurance carrier, a fleet manager, and a self-insurer.

16. The method of claim 1, further comprising reporting the data to a customer, wherein the driving performance is associated with the customer.

17. The method of claim 16, wherein reporting the data to the customer comprises providing the data to a customer interface application.

18. The method of claim 1, wherein reporting the score to the at least one user comprises sending the score from a carrier system interface to a carrier system associated with the at least one user.

19. The method of claim 1, wherein calculating the score comprises analyzing aggregate data associated with a plurality of data capturing device types.

20. The method of claim 1, wherein the platform is customizable to interface with at least one native system of a user to receive data or report the score.

21. The method of claim 1, further comprising interfacing with a gamification platform, and wherein reporting the score comprises a game-based interaction.

22. The method of claim 1, further comprising providing a data capturing device to capture the data from a vehicle.

23. A method of providing a platform for a driving performance application, comprising:
receiving data associated with driving performance of a vehicle, wherein the vehicle is associated with a client of the platform;
analyzing the data to determine a measure of driving performance; and
reporting the measure of driving performance to the client.

24. The method of claim 23, wherein reporting the measure of driving performance to the client comprises providing the measure of driving performance to a client interface.

25. The method of claim 23, further comprising communicating with an actuarial process, wherein the actuarial process is associated with the client.

26. The method of claim 25, wherein analyzing the data to determine the measure of driving performance comprises receiving actuarial data from the actuarial process.

27. The method of claim 23, wherein the platform interfaces with a native client system.

28. The method of claim 23, further comprising reporting the data to a customer of the client, wherein the driving performance is associated with the customer.

29. The method of claim 28, wherein reporting the data to the customer comprises providing the data to a customer interface application.

30. A platform for a driving performance product, comprising:
a computer system, comprising a memory and a processor, wherein the memory comprises a driving performance product application, and wherein the driving performance product application comprises logic for:
receiving data associated with driving performance;
comparing the data to a driving performance standard;
calculating a score associated with the driving performance; and
reporting the score to at least one user.

31. A computer readable medium comprising a driving performance product application, wherein the driving performance product application comprises logic for:
receiving data associated with driving performance;
comparing the data to a driving performance standard;
calculating a score associated with the driving performance; and
reporting the score to at least one user.

32. A platform for a driving performance product, comprising:
means for receiving data associated with driving performance;
means for comparing the data to a driving performance standard;
means for calculating a score associated with the driving performance; and
means for reporting the score to at least one user
